(19) United States
(12) Patent Application Publication
(10) Pub. No.: US 2002/0132220 A1
(43) Pub. Date: Sep. 19, 2002

(54) Use of selectin antagonists in organ preservation solutions

(76) Inventors: Kurt L. Berens, Houston, TX (US); Richard A.F. Dixon, Houston, TX (US); Brian Dupre, Houston, TX (US)

Correspondence Address: ROCKEY, MILNAMOW & KATZ, LTD., TWO PRUDENTIAL PLAZA, STE. 4700, 180 NORTH STETSON AVENUE, CHICAGO, IL, 60601, US

(21) Appl. No.: 10/024,081

(22) Filed: Dec. 17, 2001

Related U.S. Application Data
(60) Provisional application No. 60/258,443, filed on Dec. 27, 2000.

(51) Int. Cl. A01N 1/00; A01N 1/02

(52) U.S. Cl. 435/1.1

(57) ABSTRACT

A method for protecting a mammalian organ, tissue or cell from damage during isolation from the circulatory system by contacting a mammalian organ, tissue or cell with a solution containing at least one selectin antagonist in an amount sufficient to inhibit selectin binding and/or cell signaling is disclosed. The selectin antagonist is a small molecule inhibitor of the selectin family of adhesion molecules. A composition for preservation or maintenance of a mammalian organ, tissue or cell containing such selectin antagonists is also disclosed. A presently preferred selectin antagonist is bimosiamose disodium.

### FIELD OF THE INVENTION

This invention is directed to a method for protecting a mammalian organ, tissue or cell from damage during isolation from the circulatory system by contacting a mammalian organ, tissue or cell with a solution containing at least one selectin antagonist in an amount sufficient to inhibit selectin binding and/or cell signaling. The selectin antagonist is a small molecule inhibitor of the selectin family of adhesion molecules. The invention is also directed to a composition for preservation or maintenance of a mammalian organ, tissue or cell containing such selectin antagonists. A presently preferred selectin antagonist is bimosiamose disodium.

### BACKGROUND OF THE INVENTION

Adequate preservation of organs intended for transplantation is critical to the proper functioning of the organ following implantation. Organ preservation or maintenance solutions that can preserve organs intended for transplantation for periods of time that are longer than the conventional solutions available would be advantageous to enable cross-matching of donor and recipient to improve subsequent survival, as well as to allow for coast-to-coast and international transportation of organs to expand the donor and recipient pools.

Many different organ preservation solutions have been designed, as investigators have sought to lengthen the time that an organ may remain extra-corporeally, as well as to maximize function of the organ following implantation. Conventional solutions that have been used over the years include: 1) the Stanford University solution (see, e.g., Swanson, D. K., et al., Journal of Heart Transplantation, (1988), vol. 7, No. 6, pages 456-467; 2) Collins solution (see, e.g., Maurer, E J., et al., Transplantation Proceedings, (1990), vol. 22, No. 2, pages 548-550); 3) the University of Wisconsin solution (see, e.g., Belzer et al., U.S. Pat. No. 4,798,824) and 4) the Columbia University solution (see, e.g., Stern et al., U.S. Pat. No. 5,552,267). Certain additives to the above-mentioned preservative solutions have also been proposed, to prevent reperfusion injury in organ transplantation. For example, U.S. Pat. No. 5,002,965 discloses use of ginkgolides for this purpose; and U.S. Pat. No. 6,054,261 discloses use of Coenzyme Q for this purpose. However, there is still a need for more effective additives, and more efficient organ preservation techniques employing these additives.

### BRIEF SUMMARY OF THE INVENTION

The invention is directed to a method for protecting a mammalian organ, tissue or cell from damage during isolation from the circulatory system comprising the step of contacting a mammalian organ, tissue or cell with an effective protecting amount of at least one selectin antagonist or a pharmaceutically acceptable salt, ester, amide or prodrug thereof, in solution. The selectin antagonist may be a monovalent, divalent, or trivalent compound.

The selectin antagonist may be a divalent or trivalent compound of the structure

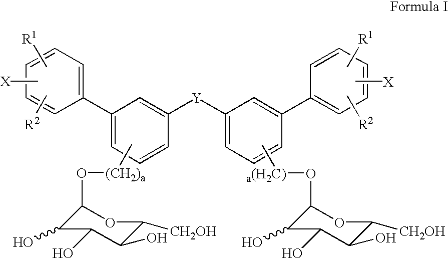

wherein R¹ and R² are each independently selected from the group consisting of hydrogen, alkyl, halogen, —OZ, —NO₂, —(CH₂)ₙCO2H, —NH₂ and —NHZ;

wherein Z is selected from the group consisting of alkyl, aryl and aralkyl;

n is an integer of 0 to 6;

X is selected from the group consisting of: —CN, —(CH₂)ₙCO₂H, —(CH₂)ₙCONHOH, —O(CH₂)ₘCO₂H, —O(CH₂)ₘCONHOH, —(CH₂)ₙCONHNH₂, —(CH₂)ₙCOZ, —(CH₂)ₙZ, —CH(CO2H)(CH₂)ₘCO₂H, —(CH₂)ₙO(CH₂)ₘCO₂H, —CONH(CH₂)ₘCO₂H, —CH(OZ)CO₂H, —CH(Z)CO₂H, —(CH₂) SO₃H, —(CH₂)ₙP(O)(OD¹)(OD²), —NH(CH₂)ₘCO₂H, —CONHCH(R³)CO₂H, (1-H-tetrazolyl-5-alkyl-) and —OH;

wherein m is an integer of 1 to 6;

R³ is selected from the group consisting of hydrogen, alkyl, aralkyl, hydroxyalkyl, aminoalkyl, alkyl carboxylic acid and alkyl carboxamide;

D¹ and D² are each independently hydrogen or alkyl;

a is an integer of 0 to 2; and

Y, when said compound is divalent, is selected from the group consisting of: —(CH₂)_{f}—, —CO(CH₂)_{f}CO—, —(CH₂)_{f}O(CH₂)_{f}−, —CO(CH₂)_{f}O(CH₂)_{f}CO—, —(CH₂)_{g}S(O)_{b}(CH₂)_{f}S(O)_{b}(CH₂)_{g}—, —CO(CH₂)_{g}S(O)_{b}(CH₂)_{f}S(O)_{b}(CH₂)_{g}CO—, —(CH₂)ₙW(CH₂)ₙ—, —(CH₂)_{f}V(CH₂)_{f}—, —(CH₂)_{f}COVCO(CH₂)_{f}—, —(CH₂)ₙWOW(CH₂)ₙ—, —CO(CH₂)_{f}COVCO(CH₂)_{f}CO—, —CO(CH₂)_{f}V(CH₂)_{f}CO—, —CONH(CH₂)_{f}NHCO—, —CO(CH₂)_{f}W(CH₂)_{f}CO—, —(CH₂)_{f}WSW(CH₂)_{f}—, —(CH₂)_{f}CONH(CH₂)_{f}NHCO(CH₂)_{f}—, —(CH₂)_{f}COW(CH₂)_{f}WCO(CH₂)_{f}—, —(CH₂)ₙS(CH₂)ₙS(CH₂)ₙ—, and —CH₂(CH₂)_{f}W(CH₂)_{f}CH₂—;

where V is —N((CH₂)_{q})ᵣN—;

wherein q is an integer of 2 to 4;

r is an integer of 1 or 2; and

W is aryl;

f is an integer of 1 to 16;

g is an integer of 0 to 6;

b is an integer of 0 or 2;

Y, when said compound is trivalent is of the structure

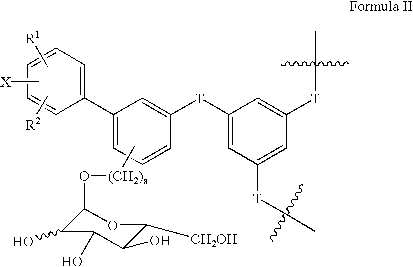

wherein T is selected from the group consisting of: —(CH₂)_{f}—, —CO(CH₂)_{f}—, —(CH₂)_{g}S(O)_{b}(CH₂)_{f}— and —CO(CH₂)_{g}S(O)_{b}(CH 2)_{f}—;

wherein when T is —CO(CH₂)_{f}— or —CO(CH₂)_{g}S(O)_{b}(CH 2)_{f}—, the carbonyl group is positioned contiguous to the biphenyl unit;

wherein D¹, D², R¹, R², R³, V, W and Z are each independently unsubstituted or substituted with at least one electron donating or electron withdrawing group;

or a pharmaceutically acceptable salt, ester, amide or prodrug thereof.

A presently preferred divalent compound is of the structure

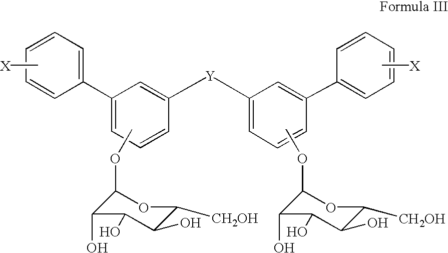

wherein X is selected from the group consisting of: —CO₂H, —(CH₂)ₙCO₂H and —O(CH₂)ₘCO₂H;

wherein n is an integer of 0 to 6;

m is an integer of 1 to 6; and

Y is selected from the group consisting of: —(CH₂)_{f}—, —(CH₂)ₙW(CH₂)ₙ—, —(CH₂)ₙWOW(CH₂)ₙ—, —(CH₂)ₙS(CH₂)ₙS(CH₂)ₙ—, —CO(CH₂)_{f}CO—, —CH₂(CH₂)_{f}W(CH₂)_{f}CH₂— and —(CH₂)_{f}COW(CH₂)_{f}WCO(CH₂)_{f}—;

wherein W is aryl;

f is an integer of I to 16;

wherein W is unsubstituted or substituted with at least one electron donating or electron withdrawing group;

or a pharmaceutically acceptable salt, ester, amide or prodrug thereof.

Presently preferred compounds of Formula III have Y as —(CH₂)_{f}— or —CH₂(CH₂)_{f}W(CH₂)_{f}CH₂—. In other presently preferred compounds of Formula III, Y is —(CH₂)_{f}— or —CH₂(CH₂)_{f}W(CH₂)_{f}CH₂—, and X is 3-CH₂CO₂H.

The monovalent compound may be of the structure

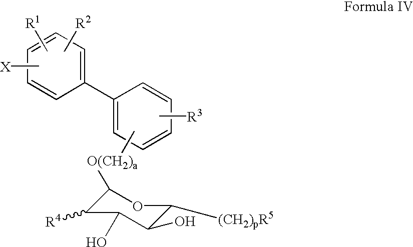

wherein R¹ and R² are each independently selected from the group consisting of hydrogen, alkyl, halogen, —OZ, —NO₂, —(CH₂)ₙCO₂H, —NH₂ and —NHZ;

wherein Z is selected from the group consisting of alkyl, aryl and aralkyl;

n is an integer of 0 to 6;

X is selected from the group consisting of: —CN, —(CH₂)ₙCO₂H, —(CH₂)ₙCONHOH, —O(CH₂)ₘCO₂H, —O(CH₂)ₘCONHOH, —(CH₂)ₙCONHNH₂, —(CH₂)ₙCOZ, —(CH₂)ₙZ, —CH(CO₂H)(CH₂)ₘCO₂H, —(CH₂)ₘO(CH₂)ₘCO₂H, —CONH(CH₂)ₘCO₂H, —CH(OZ)CO₂H, —CH(Z)CO₂H, —(CH₂)ₙSO₃H, —(CH₂)ₙP(O)(OD¹)(OD²), —NH(CH₂)ₘCO₂H, —CONHCH(R⁶)CO₂H, (1-H-tetrazolyl-5-alkyl-) and —OH;

wherein m is an integer of 1 to 6;

R⁶is selected from the group consisting of hydrogen, alkyl, aralkyl, hydroxyalkyl, aminoalkyl, alkyl carboxylic acid and alkyl carboxamide;

D¹ and D² are each independently hydrogen or alkyl;

a is an integer of 0 to 2;

p is an integer of 0 to 6;

R³ is selected from the group consisting of hydrogen, halogen, alkyl, —OZ and —NHZ;

R⁴ is select from the group consisting of hydrogen, halogen, alkyl, hydroxyl, —OSO₃H and —OZ; and

R⁵ is selected from the group consisting of hydroxyl, —CN, —NH₂, —NHNH₂, —NE¹E², —NHE¹, —NHCO(CH₂)ₙCO₂H, —S(CH₂)ₘCO₂H and —NHCHNNH₂;

wherein E¹ is alkyl or —(CH₂)_{c}CO₂H

wherein c is an integer of 1 to 18;

E² is alkyl;

wherein R¹, R², R³, R⁴, R⁵, R⁶, D¹, D², E¹, E² and Z are unsubstituted or substituted with at least one electron donating or electron withdrawing group;

or a pharmaceutically acceptable salt, ester, amide or prodrug thereof.

Presently preferred compounds include 1,7-bis-(3-(3-carboxymethylphenyl)-4-(2-α-D-mannopyranosyloxy)phenyl)heptane; 1,6-bis-(3-(3-carboxymethylphenyl)-4-(2-α-D-mannopyranosyloxy)phenyl)hexane; 1,5-bis-(3-(3-carboxymethylphenyl)-4-(2-α-D-mannopyranosyloxy)phenyl)pentane; 1,4-bis-(3-(3-carboxymethylphenyl)-4-(2-α-D-mannopyranosyloxy)phenyl)butane; N,N′-bis-(4-(3-(3-carboxymethylphenyl)-4-(2-α-D-mannopyranosyloxy)phenyl)butan-1-oyl)-4,4′-trimethylenedipiperidine; S,S′-bis-(3-(3-carboxymethylphenyl)-4-(2-α-D-mannopyranosyloxy)-3-phenylprop-1-yl)-1,3-dithiopropane; 1,7-bis-(3-(3-carboxymethylphenyl)-4-(2-α-D-mannopyranosyloxy)phenyl)-1,7-bis-oxoheptane; 1,6-bis-(3-(3-carboxymethylphenyl)-4-(2-α-D-mannopyranosyloxy)phenyl)-1,6-bis-oxohexane; 1,5-bis-(3-(3-carboxymethylphenyl)-4-(2-α-D-mannopyranosyloxy)phenyl)-1,5-bis-oxopentane; 1,4-bis-(3-(3-carboxymethylphenyl)-4-(2-α-D-mannopyranosyloxy)phenyl)-1,4-bis-oxobutane; 1,3,5-tris-(3-(3-carboxymethylphenyl)-4-(2-α-D-mannopyranosyloxy)phenylmethyl)benzene; and 1,3,5-tris-(3-(3-carboxymethylphenyl)-4-(2-α-D-mannopyranosyloxy)phenyl)-4-oxo-2-thiobutyl)benzene. A presently most preferred compound is 1,6-bis-(3-(3-carboxymethylphenyl)-4-(2-α-D-mannopyranosyloxy)phenyl)hexane, known as bimosiamose.

For the practice of the method, the selectin antagonist may have a concentration of from about 1 nanogram/milliter to about 1 milligram/milliliter; and preferably a concentration of from about 10 microgram/milliter to about 1000 microgram/milliliter in the solution. The solution may have a pH of from about 7.2 to about 7.8; and preferably a pH of from about 7.3 to about 7.6. Presently preferred solutions are Krebs-Henseleit solution, University of Wisconsin solution, St. Thomas II solution, Collins solution, Euro-Collins solution, lactated Ringers' solution, Columbia University solution and Stanford solution. Appropriate solutions may also contain additives such as electrolytes, phosphodiesterase inhibitors, buffers, antioxidants, reducing agents and bacteriostats. The solution may be maintained at a temperature of from about 0° C. to about 40° C.

In the method, the organ may be contacted by the selectin antagonist by immersion, infusion, flushing or perfusion. Also, in the method, the tissue may be a heart valve; and the organ may be a heart, liver, kidney or lung. The organs mentioned may be organs intended for transplantation.

By the use of the method, the organ may be protected from ischemia or reperfusion injury. The isolation from the circulatory system described above may be during a transplant or during an organ bypass surgery; and the organ bypass surgery is coronary bypass surgery.

The invention is also directed to a composition including the selectin antagonists described above, and Krebs-Henseleit solution, University of Wisconsin solution, St. Thomas II solution, Collins solution, Euro-Collins solution, lactated Ringers' solution, Columbia University solution or Stanford solution.

### DETAILED DESCRIPTION OF THE INVENTION

### Definitions of Terms

The term “alkyl” as used herein, alone or in combination, refers to C₁-C₁₂ straight or branched, substituted or unsubstituted saturated chain radicals derived from saturated hydrocarbons by the removal of one hydrogen atom, unless the term alkyl is preceded by a Cₓ-C_{y} designation. Representative examples of alkyl groups include methyl, ethyl, n-propyl, iso-propyl, n-butyl, sec-butyl, iso-butyl, and tert-butyl among others.

The term “lower” modifying “alkyl” refers to a C₁-C₆ unit.

The term “halo” or “halogen” as used herein refers to I, Br, Cl or F.

The term “aminoalkyl” as used herein refers to RₑNH— wherein Rₑ is an alkyl group, for example, ethylamino, butylamino, among others.

The term “tetrazolyl” as used herein refers to The term “alkyl carboxylic acid” as used herein refers to a carboxyl

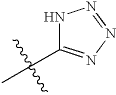

group (—CO₂H) appended to an alkyl group.

The term “alkyl carboxamide” as used herein refers to a group of the formula —CONRₓR_{y} appended to an alkyl group wherein Rₓ and R_{y} are each independently selected from hydrogen, alkyl or aryl groups.

The term “hydroxyalkyl” as used herein refers to a hydroxy group (—OH) appended to an alkyl group.

The term “aryl” or “aromatic” as used herein alone or in combination refers to a substituted or unsubstituted carbocyclic aromatic group having about 6 to 12 carbon atoms such as phenyl, naphthyl, indenyl, indanyl, azulenyl, fluorenyl and anthracenyl; or a heterocyclic aromatic group which is an aromatic ring containing at least one endocyclic N, O or S atom such as furyl, thienyl, pyridyl, pyrrolyl, oxazolyl, thiazolyl, imidazolyl, pyrazolyl, 2-pyrazolinyl, pyrazolidinyl, isoxazolyl, isothiazolyl, 1,2,3-oxadiazolyl, 1,2,3-triazolyl, 1,3,4-thiadiazolyl, pyridazinyl, pyrimidinyl, pyrazinyl, 1,3,5-triazinyl, 1,3,5-trithianyl, indolizinyl, indolyl, isoindolyl, 3H-indolyl, indolinyl, benzo[b]furanyl, 2,3-dihydrobenzofuranyl, benzo[b]thiophenyl, 1H-indazolyl, benzimidazolyl, benzthiazolyl, purinyl, 4H-quinolizinyl, isoquinolinyl, cinnolinyl, phthalazinyl, quinazolinyl, quinoxalinyl, 1,8-naphthridinyl, pteridinyl, carbazolyl, acridinyl, phenazinyl, phenothiazinyl, phenoxyazinyl, pyrazolo[1,5-c]triazinyl and the like. “Arylalkyl” and “alkylaryl” employ the term “alkyl” as defined above. Rings may be multiply substituted.

The term “aralkyl” as used herein, alone or in combination, refers to an aryl substituted alkyl radical, wherein the terms “alkyl” and “aryl” are as defined above. Examples of suitable aralkyl radicals include, but are not limited to, phenylmethyl, phenethyl, phenylhexyl, diphenylmethyl, pyridylmethyl, tetrazolyl methyl, furylmethyl, imidazolyl methyl, indolylmethyl, thienylpropyl and the like.

The term “amide” as used herein refers to a moiety ending with a —C(O)NH₂ functional group.

The term “ester” as used herein refers to —C(O)Rₘ, wherein Rₘ is hydrogen, alkyl or any other suitable substituent.

Use of the above terms is meant to encompass substituted and unsubstituted moieties. Substitution may be by one or more groups such as alcohols, ethers, esters, amides, sulfones, sulfides, hydroxyl, nitro, cyano, carboxy, amines, heteroatoms, lower alkyl, lower alkoxy, lower alkoxycarbonyl, alkoxyalkoxy, acyloxy, halogens, trifluoromethoxy, trifluoromethyl, alkyl, aralkyl, alkenyl, alkynyl, aryl, cyano, carboxy, carboalkoxy, carboxyalkyl, cycloalkyl, cycloalkylalkyl, heterocyclyl, alkylheterocyclyl, heterocyclylalkyl, oxo, arylsulfonyl and aralkylaminocarbonyl or any of the substituents of the preceding paragraphs or any of those substituents either attached directly or by suitable linkers. The linkers are typically short chains of 1-3 atoms containing any combination of —C—, —C(O)—, —NH—, —S—, —S(O)—, —O—, —C(O)O— or —S(O)O—. Rings may be substituted multiple times.

The terms “electron-withdrawing” or “electron-donating” refer to the ability of a substituent to withdraw or donate electrons relative to that of hydrogen if hydrogen occupied the same position in the molecule. These terms are well-understood by one skilled in the art and are discussed in Advanced Organic Chemistry by J. March, 1985, pp. 16-18, incorporated herein by reference. Electron withdrawing groups include halo, nitro, carboxyl, lower alkenyl, lower alkynyl, carboxaldehyde, carboxyamido, aryl, quaternary ammonium, trifluoromethyl, and aryl lower alkanoyl among others. Electron donating groups include such groups as hydroxy, lower alkyl, amino, lower alkylamino, di(lower alkyl)amino, aryloxy, mercapto, lower alkylthio, lower alkylmercapto, and disulfide among others. One skilled in the art will appreciate that the aforesaid substituents may have electron donating or electron withdrawing properties under different chemical conditions. Moreover, the present invention contemplates any combination of substituents selected from the above-identified groups.

The most preferred electron donating or electron withdrawing substituents are halo, nitro, alkanoyl, carboxaldehyde, arylalkanoyl, aryloxy, carboxyl, carboxamide, cyano, sulfonyl, sulfoxide, heterocyclyl, guanidine, quaternary ammonium, lower alkenyl, lower alkynyl, sulfonium salts, hydroxy, lower alkoxy, lower alkyl, amino, lower alkylamino, di(lower alkyl)amino, amine lower alkyl mercapto, mercaptoalkyl, alkylthio and alkyldithio.

The term “pharmaceutically acceptable prodrugs” as used herein represents those prodrugs of the selectin antagonists of the present invention which are, within the scope of sound medical judgement, suitable for use in contact with the tissues of humans and lower animals without undue toxicity, irritation, allergic response, and the like, commensurate with a reasonable benefit/risk ratio, and effective for their intended use, as well as the zwitterionic forms, where possible, of the compounds of the invention. Prodrugs of the selectin antagonists of the present invention may be rapidly transformed in vivo to the parent compounds, for example, by hydrolysis in blood. A thorough discussion is provided in T. Higuchi and V. Stella, Pro-drugs as Novel Delivery Systems, V. 14 of the A.C.S. Symposium Series, and in Edward B. Roche, ed., Bioreversible Carriers in Drug Design, American Pharmaceutical Association and Pergamon Press (1987), hereby incorporated by reference.

Asymmetric centers may exist in the selectin antagonists of the present invention. Except where otherwise noted, the present invention contemplates the various stereoisomers and mixtures thereof. Accordingly, whenever a bond is represented by a wavy line, it is intended that a mixture of stereo-orientations or an individual isomer of assigned or unassigned orientation may be present.

As used herein, the term “composition” is intended to encompass a product comprising the specified ingredients in the specified amounts, as well as any product which results, directly or indirectly, from a combination of the specified ingredients in the specified amounts.

The present invention relates to a composition for prolonged organ preservation which includes at least one selectin antagonist, and more particularly to an aqueous solution for organ preservation or maintenance which includes at least one selectin antagonist. The invention also provides a method of preserving or maintaining an organ, comprising contacting the organ with the solution for organ preservation or maintenance, which includes at least one selectin antagonist. Descriptions of the selectin antagonists, the perfusate solutions, and the method for organ preservation follow.

### The Selectin Antagonists

Monomeric selectin antagonists useful in the present invention have been disclosed in U.S. Pat. No. 5,444,050; and dimeric and trimeric selectin antagonists useful in the present invention have been disclosed in U.S. Pat. No. 5,919,768 and in WO 97/01335. Amongst the diseases which these compounds have been disclosed as useful in treating is reperfusion injury which follows heart attacks, strokes and organ transplants. However, these compounds have not been disclosed as additives to an organ preservation solution. The monomeric, dimeric or trimeric selectin antagonists may all be utilized advantageously in organ preservation solutions. However, dimeric selectin antagonists, such as bimosiamose disodium—1,6-bis-(3-(3-carbomethylphenyl)-4-(2-α-D-mannopyranosyloxy)phenyl)hexane disodium salt is presently preferred. The related dicarboxylic acid is of the structure:

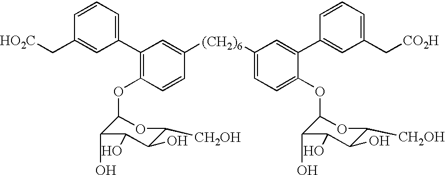

The selectin antagonists for use in the compositions and methods of the present invention can be used in the form of pharmaceutically acceptable salts derived from inorganic or organic acids. The phrase “pharmaceutically acceptable salt” means those salts which are, within the scope of sound medical judgement, suitable for use in contact with the tissues of humans and lower animals without undue toxicity, irritation, allergic response and the like and are commensurate with a reasonable benefit/risk ratio. Pharmaceutically acceptable salts are well-known in the art. For example, S. M. Berge et al. describe pharmaceutically acceptable salts in detail in J. Pharmaceutical Sciences, 1977, 66:1 et seq.

The salts can be prepared in situ during the final isolation and purification of the compounds of the invention or separately by reacting a free base function with a suitable organic acid. Representative acid addition salts include, but are not limited to acetate, adipate, alginate, citrate, aspartate, benzoate, benzene sulfonate, bisulfate, butyrate, camphorate, camphor sulfonate, digluconate, glycerophosphate, hemisulfate, heptanoate, hexanoate, fumarate, hydrochloride, hydrobromide, hydroiodide, 2-hydroxyethansulfonate (isothionate), lactate, maleate, methane sulfonate, nicotinate, 2-naphthalene sulfonate, oxalate, palmitoate, pectinate, persulfate, 3-phenylpropionate, picrate, pivalate, propionate, succinate, tartrate, thiocyanate, phosphate, glutamate, bicarbonate, p-toluene sulfonate and undecanoate. Also, the basic nitrogen-containing groups can be quatemized with such agents as lower alkyl halides such as methyl, ethyl, propyl, and butyl chlorides, bromides and iodides; dialkyl sulfates like dimethyl, diethyl, dibutyl and diamyl sulfates; long chain halides such as decyl, lauryl, myristyl and stearyl chlorides, bromides and iodides; arylalkyl halides like benzyl and phenethyl bromides and others. Water or oil-soluble or dispersible products are thereby obtained. Examples of acids which can be employed to form pharmaceutically acceptable acid addition salts include such inorganic acids as hydrochloric acid, hydrobromic acid, sulphuric acid and phosphoric acid and such organic acids as oxalic acid, maleic acid, succinic acid and citric acid.

Basic addition salts can be prepared in situ during the final isolation and purification of compounds of this invention by reacting a carboxylic acid-containing moiety with a suitable base such as the hydroxide, carbonate or bicarbonate of a pharmaceutically acceptable metal cation or with ammonia or an organic primary, secondary or tertiary amine. Pharmaceutically acceptable salts include, but are not limited to, cations based on alkali metals or alkaline earth metals such as lithium, sodium, potassium, calcium, magnesium and aluminum salts and the like and nontoxic quaternary ammonia and amine cations including ammonium, tetramethylammonium, tetraethylammonium, methylammonium, dimethylammonium, trimethylammonium, triethylammonium, diethylammonium, and ethylammonium among others. Other representative organic amines useful for the formation of base addition salts include ethylenediamine, ethanolamine, diethanolamine, piperidine, piperazine and the like.

The selectin antagonists may exist as stereoisomers wherein asymmetric or chiral centers are present. These stereoisomers are “R” or “S” depending on the configuration of substituents around the chiral carbon atom. The present invention contemplates various stercoisomers and mixtures thereof. Stereoisomers include enantiomers and diastereomers, and mixtures of enantiomers or diastereomers. Individual stereoisomers of compounds of the present invention may be prepared synthetically from commercially available starting materials which contain asymmetric or chiral centers or by preparation of racemic mixtures followed by resolution well-known to those of ordinary skill in the art. These methods of resolution are exemplified by (1) attachment of a mixture of enantiomers to a chiral auxiliary, separation of the resulting mixture of diastereomers by recrystallization or chromatography and liberation of the optically pure product from the auxiliary or (2) direct separation of the mixture of optical enantiomers on chiral chromatographic columns.

The selectin antagonists can exist in unsolvated as well as solvated forms, including hydrated forms, such as hemi-hydrates. In general, the solvated forms, with pharmaceutically acceptable solvents such as water and ethanol among others are equivalent to the unsolvated forms for the purposes of the invention.

### The Compositions

The selectin antagonists may be added to organ preservation solutions in which the organ to be transplanted is stored. At least one selectin antagonist may be utilized as an additive, however combinations of more than one selectin antagonist may also be advantageous. The additive described herein may be added to any of the conventional organ preservation solutions, to improve them.

A conventional organ preservation solution will usually possess one or more of the following properties:

(1) the solution should have an osmotic pressure which is approximately equal to the inside of a mammalian cell. The solution is usually “hyperosmolar” which means that the solution has electrolytes such as K+and or Mg+² present in an amount sufficient to produce an osmotic pressure which is slightly higher than the inside of a mammalian cell;

(2) the solution should be capable of maintaining the ATP (adenosine triphosphate) level in the cells of the organ at approximately the usual level; and

(3) the solution should allow optimum maintenance of glucose metabolism in the cells.

The organ preservation should contain an osmotic substance or a mixture of substances (e.g. electrolytes) which produce an osmotic pressure substantially the same as is present in a mammalian cell. An osmotic pressure (osmolality) of approximately 320 mOSm/l may be useful. These substances include: sugars such as dextrose, glucose, sucrose, lactose, and mannitol, with dextrose being preferred; proteins such as albumin, preferably serum albumin, more preferably human serum albumin; natural or synthetic colloids such as dextrans, polyvinyl pyrrolidine, PLURONICS, hydroxyethyl starch, FICOLL, gum arabic, polyethylene glycol and lipids; anions such as gluconate, PO₄⁻² and Cl; and cations such as K⁺, Na⁺and Mg⁺². The anions and/or cations can be provided by water soluble compounds such as potassium dihydrogen phosphate (KH₂PO₄), sodium gluconate, magnesium gluconate, calcium salts (such as CaCl₂), NaCl, KCl and potassium bicarbonate.

The organ preservation solution is usually a basic solution having a pH of about 7.1 to 7.6, preferably about 7.3 to 7.5, more preferably about 7.4. The organ preservation solution may also contain a buffer such as PO₄⁻², a bicarbonate compound such as sodium or potassium bicarbonate, and HEPES Buffer (Sigma Chemical Company) to maintain the pH at approximately the desired pH. During transplantation, the organ preservation solution is preferably kept at a cold temperature of 0° to 10° C., preferably 0° to 7° C., most preferably 5° to 7° C. or the solution may be kept at ambient temperature 20-23° C. Ambient temperature perfusion techniques are disclosed by Kasiske, B. L. et al. Transplant Proc., 22(2): 472-3, 1990.

Any organ preservation solution which has the characteristics described above may be utilized in conjunction with the disclosed selectin antagonist additives. For example, commercially available organ preservation solutions, meeting the above criteria, which may be utilized in accordance with the present invention include:

Krebs-Henseleit solution, disclosed by Schurek, H. J. et al., Pfluger's Arch., 1975, Vol. 354(4) pp. 349-365;

University of Wisconsin solution, disclosed in U.S. Pat. No. 4,798,824, containing potassium, sodium, phosphate, sulfate, lactobionate, raffinose, hydroxyethyl starch, glutathione, allopurinol, adenosine, insulin and desamethasone, available as VIASPAN from Du Pont Pharma;

St. Thomas II solution disclosed by Jynge, P. et al., Scand J. Thorac.

Cardiovasc. Surg. Suppl. 1981, Vol. 30, pp. 1-28, a solution of NaCl, NaHCO₃, KCl, MgCl₂ and CaCl₂ in water;

Collins solution, disclosed in Maurer, E J., et al., Transplantation Proceedings, (1990), vol. 22, No. 2, pages 548-550);

Euro-Collins solution, disclosed by Roberts, R. F. et al., Transplantation, Vol. 67, No. 1, pp. 152-155, a solution of potassium, sodium, magnesium, chloride, bicarbonate, phosphate, sulfate, mannitol and glucose;

lactated Ringers' solution also known as Hartmann's solution, a sterile solution of calcium chloride, potassium chloride, sodium chloride and sodium lactate in water; disclosed by Dreikorn, K. et al., Eur. Urol., 1980, vol. 6(4), pp. 221-224;

Columbia University solution, disclosed in U.S. Pat. No. 5,552,267; and

Stanford solution, disclosed in Swanson, D. K., et al., Journal of Heart Transplantation, 1988, vol. 7, No. 6, pp 456-467.

The organ preservation solution to which the selectin antagonist may be added may also contain optional ingredients including, but not limited to, an anticoagulant such as heparin; growth hormones such as insulin; an energy source (e.g., glucose and fructose); a high-energy phosphate compound (e.g., ATP and creatine phosphate); a compound which blocks cyclic AMP phosphodiesterase (e.g. pentoxifylline); a metabolite (e.g., coenzymes and amino acids); a material to remove toxic debris (activated charcoal and heavy metal chelators); a material to slow down tissue destruction (e.g., protease and peptidase inhibitors); a material to inactivate bacteria and viruses (e.g., antibiotics such as penicillin or antiviral agents such as methylene blue); a material to enhance survival in a cold environment (e.g., glycerol); a material to enhance survival during oxidative stress (e.g., glutathione and selenium, superoxide dismutase and carotene); a material to enhance wound healing (e.g., zinc oxide) and a pH indicator such as Phenol Red.

ATP may be added to the organ preservation solution. Alternatively, compounds which stimulate ATP synthesis such as adenosine, creatine phosphate or other compounds which supply PO₄⁻² may be added in an amount sufficient to stimulate ATP synthesis in an attempt to maintain the ATP level in the cells at approximately a normal level.

This invention involves preservation or maintenance solution that can preserve an organ intended for transplantation which includes at least one selectin antagonist described above. For example, the organ intended for transplantation may be a solid organ, e.g., kidney, tissue, e.g., cornea or cellular, e.g., bone marrow derived cells. While experimental work for this invention has focused on the kidney, the organ preservation or maintenance solution may be used for other organs, tissues or cells, wherever techniques similar to those used in organ preservation or maintenance apply.

The organ preservation or maintenance solution can also be used for maintaining organs during surgery or extra-corporeal perfusion procedures, because the principles of organ preservation apply. For example, the organ preservation or maintenance solution may be used during cardiopulmonary bypass surgery as an adjunct or additive to a cardioplegic solution or as an additive to circuit priming solutions used during hemodialysis.

### The Method

A brief discussion of conventional techniques for preservation of organs such as the heart and kidney follows, since the method disclosed herein may be utilized in conjunction with any of the conventional techniques.

Conventional techniques for cardiac preservation include 1) warm arrest/cold ischemia; 2) cold arrest/macroperfusion; 3) cold arrest/microperfusion; and 4) cold arrest/cold ischemic.

The first method involves arresting the heart with a warm cardioplegic solution prior to explantation and cold preservation, but this method fails because of the rapid depletion of myocardial energy stored during the warm period. The second method, which involves arresting the heart with a cold preservation solution, is better; but continuous perfusion of the heart with preservation solution during the storage period fails because of the generation of toxic oxygen radicals. In addition, the procedure of the second method is cumbersome and does not lend itself to easy clinical use. The third method, first described in a system called “trickle perfusion,” is better but also cumbersome. The fourth method of preservation is that of a cold cardioplegic arrest followed by a period of cold immersion of the heart. The fourth method is currently the standard method of cardiac preservation. This fourth method reliably preserves hearts for periods of up to six (6) hours, but less than four (4) hours is considered ideal for this method. Since a longer preservation time is desirable, attempts have been made to improve preservation solutions in such a way as to reliably preserve hearts and other organs for longer periods of time.

Methods for kidney preservation are also known, though renal preservation, the ex vivo storage of cadaveric kidneys, is a relatively new field. Preservation of cadaveric kidneys for transplantation is common practice in hospitals; however, advances have been limited to trial and error experimentation.

As renal transplantation has evolved from a strictly research procedure to an established clinical therapy for end-stage renal disease, renal preservation has progressed from the laboratory research stage to an established clinical method. At present, the two most commonly used methods for renal preservation are simple hypothermic storage and continuous perfusion. With simple hypothermic storage, the most common method of clinical renal preservation, the organs are removed from the cadaver donor and are cooled rapidly. This is usually achieved by a combination of external cooling and a short period of perfusion to drop the core temperature as quickly as possible. The kidneys are then stored, immersed in a flush-out solution in a simple plastic container, and kept at a temperature of 0° to 4° C. by immersing the container in ice. The advantages of this method are its simplicity, its low cost, and the ease of transportation of the organs. The composition of the flush-out solution to provide optimum preservation has been extensively studied.

The second method of renal preservation which has undergone extensive laboratory investigation, as well as clinical testing, is continuous pulsatile perfusion. The basic ingredients of continuous perfusion are (1) pulsatile flow, (2) hypothermia, (3) membrane oxygenation, and (4) a perfusate containing both albumin and lipids. With minor modifications, all presently used clinical preservation units share these basic principles. There are several advantages to continuous perfusion in clinical transplantation. First, perfusion provides enough time to make cadaveric transplantation a partly elective procedure. Second, it allows viability testing prior to implantation. A significant improvement in the results of cadaveric renal transplantation could be expected if the preservation time could be extended to the 5 to 7 days required for present methods of mixed lymphocyte culture testing.

The ability to successfully preserve human kidneys for two to three days by either simple cold storage after initial flushing with an intracellular electrolyte solution or by pulsatile perfusion with an electrolyte-protein solution has allowed sufficient time for histo-compatibility testing of the donor and recipient, kidney sharing among transplant centers, careful pre-operative preparation of the recipient, time for preliminary donor culture results to become available, and vascular repairs of the kidney graft prior to implantation. Kidneys preserved for 72 hours using hypothermic pulsatile perfusion with cryo-precipitated plasma proved to be a significant advance for human kidney preservation and is currently the preferred method of preservation. Kidney organ preservation with ice-cold intracellular electrolyte flush solution followed by simple cold storage has been satisfactorily employed for human kidney preservation for up to 61 hours. The disclosed method can be used to augment the conventional techniques described above. Further details concerning the disclosed method follow.

In the present method of preserving or maintaining an organ, an organ is contacted with a composition including a selectin antagonist. The “contacting” comprises immersion, infusion, flushing, or perfusion. The method can be used in an organ intended for transplantation. The organ preservation or maintenance solution may also be used during certain other surgical or medical procedures. For example, the solution may be used as an adjunct to a cardioplegic agent during cardiac surgery. The invention further provides for use during extra-corporeal procedures such as hemodialysis.

The initial experimental evidence for improved organ preservation with selectin antagonists has been demonstrated in the kidney. However, it is anticipated that similar principles of organ preservation apply to other organs as well, such that the organ preservation or maintenance solution might be used successfully to preserve hearts, livers, pancreases, lungs, and corneas among others. In general, the organ preservation or maintenance solution may be used for cells and tissues, as well as for organs. That is, the organ preservation or maintenance solution may be used for those situations that involve leukocyte activation, recruitment and reperfusion injury.

In addition, the principles of organ preservation apply to cardioplegic agents used to arrest the heart during cardiac surgery, so that the organ preservation or maintenance solution may have a role as an adjunct to cardioplegic agents. The solution may also be used for other medical procedures associated with ischemia/reperfusion injury, such as myocardial infarction, thrombolysis, or percutaneous transluminal coronary angioplasty.

Minor modifications in the composition of the organ preservation or maintenance solution might have to be made according to the type of organ being transplanted, or to accommodate certain other surgical, medical, or other considerations. The composition of the organ preservation or maintenance solution might also be different when the solution is being used as an adjunct to a cardioplegic agent in cardiac surgery, or in some other appropriate surgical procedure, than when the solution is being used for organ transplantation. The composition might also require adjustment depending upon certain other circumstances. For instance, the composition might have to be varied depending upon whether the organ is being transported or is in idle storage, the distance of the transportation, the time of transportation, the temperature during storage or transportation, and other factors. Such variations or adjustments in the composition of the organ preservation or maintenance solution which might be required would be obvious to those skilled in organ transplantation or surgical procedures.

The amount of the organ preservation or maintenance solution required in transplantation or surgical procedure may vary.

The organ preservation or maintenance solution is suitable for use at the low temperatures that may be required during transplantation or other surgical procedure. For instance, temperatures of about zero to about four degrees Centigrade may be required during an organ transplantation or surgical procedure. Ambient temperatures may also be utilized, as indicated above.

The invention also provides a method of preserving or maintaining an organ, comprising contacting the organ with the solution for organ preservation or maintenance. The contacting comprises immersion, infusion, flushing, or perfusion. Other suitable procedures of contacting are included. The method can be used wherein the organ is an organ intended for transplantation. The method can be used wherein the organ is a heart. For example, the method can be used wherein the heart is involved in cardiac surgery. Hence, the organ preservation or maintenance solution may be used in organ transplantation procedures. The organ preservation or maintenance solution may also be used during certain other surgical or medical procedures; for example, the solution may be used as a cardioplegic agent during cardiac surgery.

The Examples are presented to describe preferred embodiments and utilities of the invention and are not meant to limit the invention unless otherwise stated in the claims appended hereto.

### EXAMPLE 1

To determine the effects of bimosiamose on the ischemia/reperfusion component of transplant injury, the following experiment was performed. To test bimosiamose solutions, a rat kidney is flushed with a solution containing bimosiamose (compound 1, 1,6-bis-(3-(3-carbomethylphenyl)-4-(2-α-D-mannopyranosyloxy)phenyl)hexane disodium salt, prepared according to the procedure described in U.S. Pat. No. 5,919,768) upon harvest from a donor and prior to placement into a recipient, to determine whether or not there is any protective effect. Rats for both examples were supplied by Harlan. A syngeneic transplantation model (Lewis rat to Lewis rat) was utilized. In this model, the immune system mediated rejection component is not relevant since the donor and recipient are of similar genetic background (syngeneic). In this experiment, test bimosiamose solutions were made up in a concentration of 100 mg/ml in phosphate-buffered saline solution, at a pH of 7.4. Test amounts of bimoisamose solution (as indicated in column 1 of Table 1) were added to Collins solution, to form the test perfusate solution. The Collins solution was purchased from Baxter, and contained 740 mg dibasic potassium phosphate, 205 mg monobasic potassium phosphate, 112 mg potassium chloride and 84 mg sodium bicarbonate per 100 mL solution, at pH 7.4. The test perfusate solution was cooled to a temperature of 4° C., and then 2 ml was utilized to perfuse the organ, which was afterwards maintained on ice for thirty minutes. Perfusion pressure was at or below physiologic pressure during the perfusion.

Following the 30 minute cold-temperature perfusion, transplantation was performed by transplanting a graft organ using end-to-end anastomosis of the renal artery, vein and ureter, with a simultaneous contralateral nephrectomy, wherein when the graft fails, the recipient does shortly thereafter.

Renal function (as indexed by glomerular filtration rate (GFR)) is markedly reduced as a result of the ischemia/reperfusion injury associated with the transplant procedure, in the absence of treatment, as evidenced by a comparison of row 2 with row 1 in Table 1. This injury is the result of 30 minutes of cold ischemia with an additional 30 minutes of warm ischemia during the surgical re-anastomosis. N in the first column of Table 1 indicates sample size, i.e.—when N=6, six animals were tested. Simply flushing the organ with a solution containing 1 mg/2 ml or 2 mg/2 ml of bimosiamose results in a preservation of renal function. These observations are supported by reductions in serum creatinine and blood urea nitrogen (see Table 1). Therefore, Table 1 illustrates a statistically significant improvements associated with bimosiamose treatment.

TABLE 1
Syngeneic Transplantation

| | | Serum | Blood Urea |
|---|---|---|---|
| | GFR | Creatinine | Nitrogen |
| Conditions | (ml/min) | (mg/dL) | (mg/dL) |
| No transplantation | 0.99 ± 0.17 | 0.42 ± 0.08 | 26.2 ± 2.6 |
| (N = 6) | | | |
| Transplantation, but no | 0.57 ± 0.24 | 0.68 ± 0.16 | 56.6 ± 17.6 |
| treatment¹ | | | |
| (N = 5) | | | |
| Transplantation, with | 0.70 ± 0.37 | 0.62 ± 0.23 | 49.8 ± 24.2 |
| treatment of 0.5 mg/ml | | | |
| Cmpd. 1 | | | |
| (N = 5) | | | |
| Transplantation, with | 0.91 ± 0.08 | 0.48 ± 0.08 | 32.0 ± 4.6 |
| treatment of 1.0 mg/ml | | | |
| Cmpd. 1 | | | |
| (N = 5) | | | |

¹= organ is perfused with Collins solution only

### EXAMPLE 2

The procedure described in Example 1 was also utilized to determine what effect bimosiamose solutions would have when transplantation between donor and recipient were not matched for histocompatibility (test rats are allogenic).

Table 2 shows the effects of bimosiamose when administered by flushing kidneys prior to allogeneic transplantation. Rat kidneys are transplanted from Lewis rats to ACI rats. If no immunosuppression is provided (Sham) allografts are rapidly rejected (<10 days), as reflected in row I of Table 2. However, if renal allografts are flushed with a solution containing bimosiamose, there is a dose-related preservation of graft function/survival. This effect is observed without concomitant administration of standard immunosuppressive agents (e.g., cyclosporine, azathioprine, corticosteroids). Therefore, Table 2 shows that addition of bimosiamose solution increases the rate of survival for kidney transplant recipients.

TABLE 2
Allogeneic Transplantation

| | Survival |
|---|---|
| Conditions | (days) |
| Transplantation without Treatment | 8.83 ± 0.75 |
| (N = 6) | |
| Transplantation, with treatment of 0.5 mg/ml | 18.50 ± 6.45 |
| Cmpd. 1 | |
| (N = 4) | |
| Transplantation, with treatment of 1.0 mg/ml | 30.25 ± 13.25 |
| Cmpd. 1 | |
| (N = 4) | |

All references cited are hereby incorporated by reference.

The present invention is illustrated by way of the foregoing description and examples. The foregoing description is intended as a non-limiting illustration, since many variations will become apparent to those skilled in the art in view thereof. It is intended that all such variations within the scope and spirit of the appended claims be embraced thereby.

Changes can be made in the composition, operation and arrangement of the method of the present invention described herein without departing from the concept and scope of the invention as defined in the following claims:

We claim:

1. A method for protecting a mammalian organ, tissue or cell from damage during isolation from the circulatory system comprising the step of contacting a mammalian organ, tissue or cell with an effective protecting amount of at least one selectin antagonist or a pharmaceutically acceptable salt, ester, amide or prodrug thereof, in solution.

2. The method of claim 1 wherein said selectin antagonist is a monovalent, divalent, or trivalent compound.

3. The method of claim 2 wherein said selectin antagonist is at least one divalent or trivalent compound of the structure 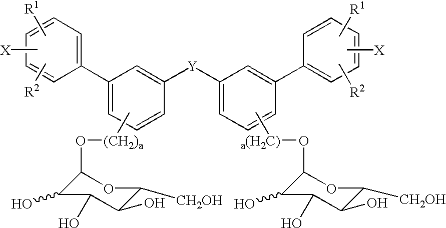
wherein R¹ and R² are each independently selected from the group consisting of hydrogen, alkyl, halogen, —OZ, —NO₂, —(CH₂)ₙCO₂H, —NH₂ and —NHZ;
wherein Z is selected from the group consisting of alkyl, aryl and aralkyl;
n is an integer of 0 to 6;
X is selected from the group consisting of: —CN, —(CH₂)ₙCO₂H, —(CH₂)ₙCONHOH, —O(CH₂)ₘCO₂H, —O(CH₂)ₘCONHOH, —(CH₂)ₙCONHNH₂, —(CH₂)ₙCOZ, —(CH₂)ₙZ, —CH(CO₂H)(CH₂)ₘCO₂H, —(CH₂)ₙO(CH₂)ₘCO₂H, —CONH(CH₂)ₘCO₂H, —CH(OZ)CO₂H, —CH(Z)CO₂H, —(CH₂)ₙSO₃H, —(CH₂)ₙP(O)(OD¹)(OD²), —NH(CH₂)ₘCO₂H, —CONHCH(R³)CO₂H, (1-H-tetrazolyl-5-alkyl-) and —OH;
wherein m is an integer of 1 to 6;
R³ is selected from the group consisting of hydrogen, alkyl, aralkyl, hydroxyalkyl, aminoalkyl, alkyl carboxylic acid and alkyl carboxamide;
D¹ and D² are each independently hydrogen or alkyl;
a is an integer of 0 to 2; and
Y, when said compound is divalent, is selected from the group consisting of: —(CH₂)_{f}—, —CO(CH₂)_{f}CO—, —(CH₂)_{f}O(CH₂)_{f}—, —CO(CH₂)_{f}O(CH₂)_{f}CO—, —(CH₂)_{g}S(O)_{b}(CH₂)_{f}S(O)b(CH₂)_{g}—, —CO(CH₂)_{g}S(O)_{b}(CH₂)_{f}S(O)_{b}(CH₂)_{g}CO—, —(CH₂)ₙW(CH₂)ₙ—, —(CH₂)_{f}V(CH₂)_{f}—, —(CH₂)_{f}COVCO(CH₂)_{f}—, —(CH₂)ₙWOW(CH₂)ₙ—, —CO(CH₂)_{f}COVCO(CH₂)_{f}CO—, —CO(CH₂)_{f}V(CH₂)_{f}CO—, —CONH(CH₂)_{f}NHCO—, —CO(CH₂)_{f}W(CH₂)_{f}CO—, —(CH₂)_{f}WSW(CH₂)_{f}—, —(CH₂)_{f}CONH(CH₂)_{f}NHCO(CH₂)_{f}—, —(CH₂)_{f}COW(CH₂)_{f}WCO(CH₂)_{f}—, —(CH₂)ₙS(CH₂)ₙS(CH₂)ₙ—, and —CH₂(CH₂)_{f}W(CH₂)_{f}CH₂—;
where V is —N((CH₂)_{q})ᵣN—;
wherein q is an integer of 2 to 4;
r is an integer of 1 or 2; and
W is aryl;
f is an integer of 1 to 16;
g is an integer of 0 to 6;
b is an integer of 0 or 2;
Y, when said compound is trivalent is of the structure 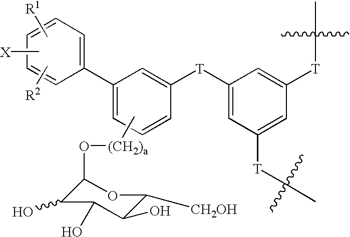
wherein T is selected from the group consisting of —(C₂)_{f}—, —CO(CH₂)_{f}—, —(CH₂)_{g}S(O)_{b}(CH₂)_{f}— and —CO(CH₂)_{g}S(O)_{b}(CH₂)_{f}—;
wherein when T is —CO(CH₂)_{f}— or —CO(CH₂)_{g}S(O)_{b}(CH₂)_{f}—, the carbonyl group is positioned contiguous to the biphenyl unit;
wherein D¹, D², R¹, R², R³, V, W and Z are each independently unsubstituted or substituted with at least one electron donating or electron withdrawing group.

4. A method for protecting a mammalian organ, tissue or cell from damage during isolation from the circulatory system comprising the step of contacting a mammalian organ, tissue or cell with an effective protecting amount of at least one compound of the structure 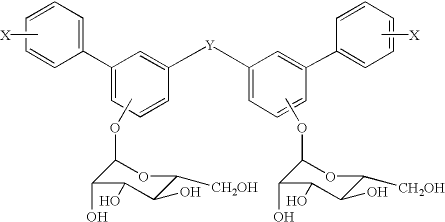
wherein X is selected from the group consisting of: —CO₂H, —(CH₂)ₙO₂H and —O(CH₂)ₘCO₂H;
wherein n is an integer of 0 to 6;
m is an integer of 1 to 6; and
Y is selected from the group consisting of: —(CH₂)_{f}—, —(CH₂)ₙW(CH₂)ₙ—, —(CH₂)ₙWOW(CH₂)ₙ—, —(CH₂)ₙS(CH₂)ₙ, S(CH₂)ₙ—, —CO(CH₂)_{f}CO—, —CH₂(CH₂)_{f}W(CH₂)_{f}CH₂— and —(CH₂)_{f}COW(CH₂)_{f}WCO(CH₂)_{f}—;
wherein W is aryl;
f is an integer of 1 to 16;
wherein W is unsubstituted or substituted with at least one electron donating or electron withdrawing group;
or a pharmaceutically acceptable salt, ester, amide or prodrug thereof, in solution.

5. The method of claim 4 wherein Y is —(CH₂)_{f}— or —CH₂(CH₂)_{f}W(CH₂)_{f}CH₂—.

6. The method of claim 4 wherein Y is —(CH₂)_{f}— or —CH₂(CH₂)_{f}W(CH₂)_{f}CH₂—, and X is 3-CH₂CO₂H.

7. The method of claim 1 wherein said selectin antagonist is selected from the group consisting of: 1,7-bis-(3-(3-carboxymethylphenyl)-4-(2-α-D-mannopyranosyloxy)phenyl)heptane, 1,6-bis-(3-(3-carboxymethylphenyl)-4-(2-α-D-mannopyranosyloxy)phenyl)hexane, 1,5-bis-(3-(3-carboxymethylphenyl)-4-(2-α-D-mannopyranosyloxy)phenyl)pentane, 1,4-bis-(3-(3-carboxymethylphenyl)-4-(2-α-D-mannopyranosyloxy)phenyl)butane, N,N′-bis-(4-(3-(3-carboxymethylphenyl)-4-(2-α-D-mannopyranosyloxy)phenyl)butan-1-oyl)-4,4′-trimethylenedipiperidine, S,S′-bis-(3-(3-carboxymethylphenyl)-4-(2-α-D-mannopyranosyloxy)-3-phenylprop-1-yl)-1,3-dithiopropane, 1,7-bis-(3-(3-carboxymethylphenyl)-4-(2-α-D-mannopyranosyloxy)phenyl)-1,7-bis-oxoheptane, 1,6-bis-(3-(3-carboxymethylphenyl)-4-(2-α-D-mannopyranosyloxy)phenyl)-1,6-bis-oxohexane; 1,5-bis-(3-(3-carboxymethylphenyl)-4-(2-α-D-mannopyranosyloxy)phenyl)-1,5-bis-oxopentane, 1,4-bis-(3-(3-carboxymethylphenyl)-4-(2-α-D-mannopyranosyloxy)phenyl)-1,4-bis-oxobutane, 1,3,5-tris-(3-(3-carboxymethylphenyl)-4-(2-α-D-mannopyranosyloxy)phenylmethyl)benzene, 1,3,5-tris-(3-(3-carboxymethylphenyl)-4-(2-α-D-mannopyranosyloxy)phenyl)-4-oxo-2-thiobutyl)benzene and pharmaceutically acceptable salts thereof.

8. The method of claim 1 wherein said selectin antagonist is 1,6-bis-(3-(3-carboxymethylphenyl)-4-(2-α-D-mannopyranosyloxy)phenyl)hexane or a pharmaceutically acceptable salt thereof.

9. The method of claim 2 wherein said selectin antagonist is a monovalent compound of the structure 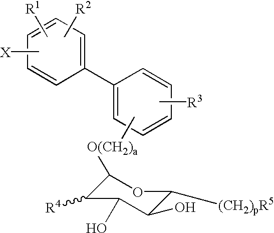
wherein R¹ and R² are each independently selected from the group consisting of hydrogen, alkyl, halogen, —OZ, —NO₂, —(CH₂)ₙCO₂H, —NH₂ and —NHZ;
wherein Z is selected from the group consisting of alkyl, aryl and aralkyl;
n is an integer of 0 to 6;
X is selected from the group consisting of: —CN, —(CH₂)ₙCO₂H, —(CH₂)ₙCONHOH, —O(CH₂)ₘCO₂H, —O(CH₂)ₘCONHOH, —(CH₂)ₙCONHNH₂, —(CH₂)ₙCOZ, —(CH₂)ₙZ, —CH(CO₂H)(CH₂)ₘCO₂H, —(CH₂)ₙO(CH₂)ₘCO₂H, —CONH(CH₂)ₘCO₂H, —CH(OZ)CO₂H, —CH(Z)CO₂H, —(CH₂)ₙSO₃H, —(CH₂)ₙP(O)(OD¹)(OD²), —NH(CH₂)ₘCO₂H, —CONHCH(R³)CO₂H, (1-H-tetrazolyl-5-alkyl-) and —OH;
wherein m is an integer of 1 to 6;
R¹ is selected from the group consisting of hydrogen, alkyl, aralkyl, hydroxyalkyl, aminoalkyl, alkyl carboxylic acid and alkyl carboxamide;
D¹ and D² are each independently hydrogen or alkyl;
a is an integer of 0 to 2;
p is an integer of 0 to 6;
R³ is selected from the group consisting of hydrogen, halogen, alkyl, —OZ and —NHZ;
R⁴ is select from the group consisting of hydrogen, halogen, alkyl, hydroxyl, —OSO₃H and —OZ; and
R⁵ is selected from the group consisting of hydroxyl, —CN, —NH₂, —NHNH₂, —NE¹E², —NHE¹, —NHCO(CH₂)ₙCO₂H, —S(CH₂)ₘCOH and —NHCHNHNH₂;
wherein E¹ is alkyl or —(CH₂)ₙCO₂H
wherein c is an integer of 1 to 18;
E² is alkyl;
wherein R¹, R², R³, R⁴, R⁵, R⁶, D¹, D², E¹, E² and Z are unsubstituted or substituted with at least one electron donating or electron withdrawing group;
or a pharmaceutically acceptable salt, ester, amide or prodrug thereof.

10. The method of claim 1 wherein said selectin antagonist has a concentration of from about 1 nanogram/milliter of said solution to about 1 milligram/milliliter of said solution.

11. The method of claim 1 wherein said selectin antagonist has a concentration of from about 10 microgram/milliter of said solution to about 1000 microgram/milliliter of said solution.

12. The method of claim 1 wherein said solution has a pH of from about 7.2 to about 7.8.

13. The method of claim 1 wherein said solution has a pH of from about 7.3 to about 7.6.

14. The method of claim 1 wherein said solution is selected from the group consisting of Krebs-Henseleit solution, University of Wisconsin solution, St. Thomas II solution, Collins solution, Euro-Collins solution, lactated Ringers' solution, Columbia University solution and Stanford solution.

15. The method of claim 1 wherein said tissue is a heart valve.

16. The method of claim 1 wherein said organ is a heart, liver, kidney or lung.

17. The method of claim 1 wherein said solution further comprises an additive selected from the group consisting of: electrolytes, phosphodiesterase inhibitors, buffers, antioxidants, reducing agents and bacteriostats.

18. The method of claim 1 wherein said solution is at a temperature of from about 0° C. to about 40° C.

19. The method of claim 1 wherein contacting is by immersion, infusion, flushing or perfusion.

20. The method of claim 1 wherein said organ is an organ intended for transplantation.

21. The method of claim 1 wherein said organ is protected from ischemia or reperfusion injury.

22. The method of claim 1 wherein said isolation from the circulatory system is during a transplant or during an organ bypass surgery.

23. The method of claim 22 wherein said organ bypass surgery is coronary bypass surgery.

24. A composition for preservation or maintenance of a mammalian organ, tissue or cell, comprising:
at least one selectin antagonist;
in a solution selected from the group consisting of Krebs-Henseleit solution, University of Wisconsin solution, St. Thomas II solution, Collins solution, Euro-Collins solution, lactated Ringers' solution, Columbia University solution and Stanford solution.

25. The composition of claim 24 wherein said selectin antagonist is a monovalent, divalent, or trivalent compound.

26. The composition of claim 25 wherein said selectin antagonist is a divalent or trivalent compound of the structure 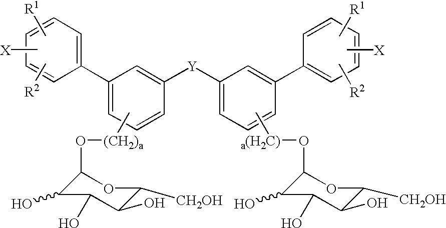
wherein R¹ and R² are each independently selected from the group consisting of hydrogen, alkyl, halogen, —OZ, —NO₂, —(CH₂)ₙCO₂H, —NH₂ and —NHZ;
wherein Z i s selected from the group consisting of alkyl, aryl and aralkyl;
n is an integer of 1 to 6;
X is selected from the group consisting of: —CN, —(CH₂)ₙCO₂H, —(CH₂)ₙCONHOH, —O(CH₂)ₘCO₂H, —O(CH₂)ₘCONHOH, 35 —(CH₂)ₙCONHNH₂, —(CH₂)ₙCOZ, —(CH₂)ₙZ, —CH(CO₂H)(CH₂)ₘCO₂H, —(CH₂)ₙO(CH₂)ₘCO₂H, —CONH(CH₂)ₘCO₂H, —CH(OZ)CO₂H, —CH(Z)CO₂H, —(CH₂)ₙSO₃H, —(CH₂)ₙP(O)(OD¹)(OD²), —NH(CH₂)ₘCO₂H, —CONHCH(R³)CO₂H, (1-H-tetrazolyl-5-alkyl-) and —OH;
wherein m is an integer of 1 to 6;
R³ is selected from the group consisting of hydrogen, alkyl, aralkyl, hydroxyalkyl, aminoalkyl, alkyl carboxylic acid and alkyl carboxamide;
D¹ and D² are each independently hydrogen or alkyl;
a is an integer of 0 to 2; and
Y, when said compound is divalent, is selected from the group consisting of: —(CH₂)_{f}—, —CO(CH₂)_{f}CO—, —(CH₂)_{f}O(CH₂)_{f}—, —CO(CH₂)_{f}O(CH₂)_{f}CO—, —(CH₂)_{g}S(O)_{b}(CH₂)_{f}S(O)b(CH₂)_{g}—, —CO(CH₂)_{g}S(O)_{b}(CH₂)_{f}S(O)_{b}(CH₂)_{g}CO—, —(CH₂)ₙW(CH₂)ₙ—, —(CH₂)_{f}V(CH₂)_{f}—, —(CH₂)_{f}COVCO(CH₂)_{f}—, —(CH₂)ₙWOW(CH₂)ₙ—, —CO(CH₂)_{f}COVCO(CH₂)_{f}CO—, —CO(CH₂)_{f}V(CH₂)_{f}CO—, —CONH(CH₂)_{f}NHCO—, —CO(CH₂)_{f}W(CH₂)_{f}CO—, —(CH₂)_{f}WSW(CH₂)_{f}—, —(CH₂)_{f}CONH(CH₂)_{f}NHCO(CH₂)_{f}—, —(CH₂)_{f}COW(CH₂)_{f}WCO(CH₂)_{f}—, —(CH₂)ₙS(CH₂)ₙS(CH₂)ₙ—, and —CH₂(CH₂)_{f}W(CH₂)_{f}CH₂—;
where V is —N((CH₂)_{q})ᵣN—;
wherein q is an integer of 2 to 4;
r is an integer of 1 or 2; and
W is aryl;
f is an integer of 1 to 16;
g is an integer of 0 to 6;
b is an integer of 0 or 2;
Y, when said compound is trivalent is of the structure 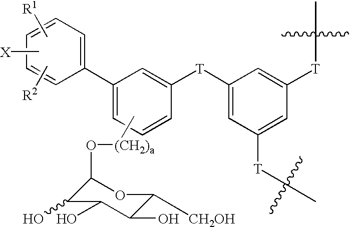
wherein T is selected from the group consisting of: —(CH₂)_{f}—, —CO(CH₂)_{f}—, —(CH₂)_{g}S(O)_{b}(CH₂)_{f}— and —CO(CH₂)_{g}S(O)_{b}(CH 2)_{f}—;
wherein when T is —CO(CH₂)_{f}— or —CO(CH₂)_{g}S(O)_{b}(CH 2)_{f}—, the carbonyl group is positioned contiguous to the biphenyl unit;
wherein D¹, D², R¹, R², R³, V, W and Z are each independently unsubstituted or substituted with at least one electron donating or electron withdrawing group;
or a pharmaceutically acceptable salt, ester, amide or prodrug thereof.

27. A composition for preservation or maintenance of a mammalian organ, tissue or cell, comprising:
at least one selectin antagonist of the structure 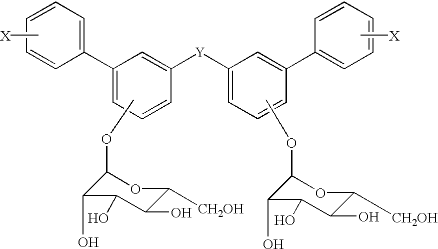
wherein X is selected from the group consisting of: —CO₂H, —(CH₂)ₙCO₂H and —O(CH₂)ₘCO₂H;
wherein n is an integer of 0 to 6;
m is an integer of 1 to 6; and
Y is selected from the group consisting of: —(CH₂)_{f}—, —(CH₂)ₙW(CH₂)ₙ—, —(CH₂)WOW(CH₂)ₙ—, —(CH₂)ₙS(CH₂)ₙS(CH₂)ₙ—, —CO(CH₂)_{f}CO—, —CH₂(CH₂)_{f}W(CH₂)_{f}CH₂— and —(CH₂)_{f}COW(CH₂)_{f}WCO(CH₂)_{f}—;
wherein W is aryl;
f is an integer of 1 to 16;
wherein W is unsubstituted or substituted with at least one electron donating or electron withdrawing group;
or a pharmaceutically acceptable salt, ester, amide or prodrug thereof;
in a solution selected from the group consisting of Krebs-Henseleit solution, University of Wisconsin solution, St. Thomas II solution, Collins solution, Euro-Collins solution, lactated Ringers' solution, Columbia University solution and Stanford solution.

28. The composition of claim 27 wherein Y is —(CH₂)_{f}— or —CH₂(CH₂)_{f}W(CH₂)_{f}CH₂—.

29. The composition of claim 27 wherein Y is —(CH₂)_{f}— or —CH₂(CH₂)_{f}W(CH₂)_{f}CH₂—, and X is 3-CH₂CO₂H.

30. The composition of claim 24 wherein said selectin antagonist is selected from the group consisting of: 1,7-bis-(3-(3-carboxymethylphenyl)-4-(2-α-D-mannopyranosyloxy)phenyl)heptane, 1,6-bis-(3-(3-carboxymethylphenyl)-4-(2-α-D-mannopyranosyloxy)phenyl)hexane, 1,5-bis-(3-(3-carboxymethylphenyl)-4-(2-α-D-mannopyranosyloxy)phenyl)pentane, 1,4-bis-(3-(3-carboxymethylphenyl)-4-(2-α-D-mannopyranosyloxy)phenyl)butane, N,N′-bis-(4-(3-(3-carboxymethylphenyl)-4-(2-α-D-mannopyranosyloxy)phenyl)butan-1-oyl)4,4′-trimethylenedipiperidine, S,S′-bis-(3-(3-carboxymethylphenyl)-4-(2-α-D-mannopyranosyloxy)-3-phenylprop-1-yl)-1,3-dithiopropane, 1,7-bis-(3-(3-carboxymethylphenyl)-4-(2-α-D-mannopyranosyloxy)phenyl)-1,7-bis-oxoheptane, 1,6-bis-(3-(3-carboxymethylphenyl)-4-(2-α-D-mannopyranosyloxy)phenyl)-1,6-bis-oxohexane; 1,5-bis-(3-(3-carboxymethylphenyl)-4-(2-α-D-mannopyranosyloxy)phenyl)-1,5-bis-oxopentane, 1,4-bis-(3-(3-carboxymethylphenyl)-4-(2-α-D-mannopyranosyloxy)phenyl)-1,4-bis-oxobutane, 1,3,5-tris-(3-(3-carboxymethylphenyl)-4-(2-α-D-mannopyranosyloxy)phenylmethyl)benzene, 1,3,5-tris-(3-(3-carboxymethylphenyl)-4-(2-α-D-mannopyranosyloxy)phenyl)-4-oxo-2-thiobutyl)benzene and pharmaceutically acceptable salts thereof.

31. The composition of claim 24 wherein said selectin antagonist is 1,6-bis-(3-(3-carboxymethylphenyl)-4-(2-α-D-mannopyranosyloxy)phenyl)hexane or a pharmaceutically acceptable salt thereof.

32. The composition of claim 25 wherein said selectin antagonist is a monovalent compound of the structure 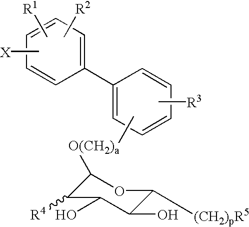
wherein R¹ and R² are each independently selected from the group consisting of hydrogen, alkyl, halogen, —OZ, —NO₂, —(CH₂)ₙCO₂H, —NH₂ and —NHZ;
wherein Z is selected from the group consisting of alkyl, aryl and aralkyl;
n is an integer of 0 to 6;
X is selected from the group consisting of: —CN, —(CH₂)ₙCO₂H, —(CH₂)ₙCONHOH, —O(CH₂)ₘCO₂H, —O(CH₂)ₘCONHOH, —(CH₂)ₙCONHNH₂, —(CH₂)ₙCOZ, —(CH₂)ₙZ, —CH(CO₂H)(CH₂)ₘCO₂H, —(CH₂)ₙO(CH₂)ₘCO₂H, —CONH(CH₂)ₘCO₂H, —CH(OZ)CO₂H, —CH(Z)CO₂H, —(CH₂)ₙSO₃H, —(CH₂)ₙP(O)(OD¹)(OD²), —NH(CH₂)ₘCO₂H, —CONHCH(R³)CO₂H, (1-H-tetrazolyl-5-alkyl-) and —OH;
wherein m is an integer of 1 to 6;
R⁶ is selected from the group consisting of hydrogen, alkyl, aralkyl, hydroxyalkyl, aminoalkyl, alkyl carboxylic acid and alkyl carboxamide;
D¹ and D² are each independently hydrogen or alkyl;
a is an integer of 0 to 2;
p is an integer of 0 to 6;
R³ is selected from the group consisting of hydrogen, halogen, alkyl, —OZ and —NHZ;
R⁴ is select from the group consisting of hydrogen, halogen, alkyl, hydroxyl, —OSO₃H and —OZ; and
R¹ is selected from the group consisting of hydroxyl, —CN, —NH_{2,} —NHNH₂, —NE¹E²,—NHE¹, —NHCO(CH₂)ₙCO₂H, —S(CH₂)ₘCO₂H and —NHCHNNH₂;
wherein E¹ is alkyl or —(CH₂)_{c}CO₂H wherein c is an integer of 1 to 18;
E² is alkyl;
wherein R¹, R², R³, R⁴, R⁵, R⁶, D¹, D², E¹, E² and Z are unsubstituted or substituted with at least one electron donating or electron withdrawing group;
or a pharmaceutically acceptable salt, ester, amide or prodrug thereof.

33. The composition of claim 24 wherein said selectin antagonist has a concentration of from about 1 nanogram/milliter of said solution to about 1 milligram/milliliter of said solution.

34. The composition of claim 24 wherein said selectin antagonist has a concentration of from about 10 microgram/milliter of said solution to about 1000 microgram/milliliter of said solution.

35. The composition of claim 24 having a pH of from about 7.2 to about 7.8.

36. The composition of claim 24 having a pH of from about 7.3 to about 7.6.

37. The composition of claim 24 further comprising an additive selected from the group consisting of: electrolytes, phosphodiesterase inhibitors, buffers, antioxidants, reducing agents and bacteriostats.
